(19) United States
(12) Patent Application Publication
(10) Pub. No.: US 2010/0194551 A1
(43) Pub. Date: Aug. 5, 2010

(54) Display device for two-way anti-theft remote controller

(76) Inventor: Tse Hsing Chen, Chung-Ho City (TW)

Correspondence Address: BACON & THOMAS, PLLC, 625 SLATERS LANE, FOURTH FLOOR, ALEXANDRIA, VA, 22314-1176, US

(21) Appl. No.: 12/320,807

(22) Filed: Feb. 5, 2009

(51) Int. Cl. B60R 25/10

(52) U.S. Cl. 340/426.15

(57) ABSTRACT

A display device for two-way anti-theft remote controller is provided with an auxiliary indicator lamp, which can flash in different manners or show different colors to substitute for a color screen to effectively warn a car owner about a current car state without consuming a large amount of power; and a light sensor, which enables the color screen of the display device to automatically switch between a color and a monochrome presentation mode when an ambient light source changes. Therefore, the color screen can switch to the monochrome presentation mode or show high-contrast images when the light sensor is exposed to a strong light, enabling the car owner to always clearly see and conveniently operate the anti-theft remote controller on the color screen.

### FIELD OF THE INVENTION

The present invention relates to a display device for two-way anti-theft remote controller, which includes an auxiliary indicator lamp capable of flashing in different manners or showing different colors to effectively warn a car owner about the current car state at low power consumption, and a light sensor enabling a color screen of the display device to automatically switch between a color presentation mode and a monochrome presentation mode when an ambient light source changes.

### BACKGROUND OF THE INVENTION

Cars are very important traffic means in the modern society and bring a lot of convenience to people in their daily life. However, there are also many car thieves who form a troublesome problem to all car owners. Thus, various kinds of auto anti-theft products have been developed and introduced into the market. A car owner will usually buy and install a car security system, so that a warning signal can be immediately emitted by the system as soon as a car thief invades the car.

Following the progress in the technical fields, new generations of anti-theft products are now provided with versatile functions, including various security measures to thoroughly stop the car thieves. A new generation car security system usually includes a two-way anti-theft remote controller. To attract more consumers, the two-way anti-theft remote controller not only provides sound and vibration to warn a car owner about the current car state, but also includes a liquid crystal display (LCD) to show the current car state. The early stage LCD for the anti-theft remote controller is usually a monochrome LCD, which has the advantage of low manufacturing cost and low power consumption, and can therefore be turned on all the time for showing the current car state without consuming too much power.

The monochrome LCD for the two-way anti-theft remote controller has gradually been replaced by a color screen, such as color thin-film transistor (TFT) LCD, color super-twisted nematic (STN) display, organic light emitting diode (OLED) display, etc. However, the color screen has the disadvantage of relatively high power consumption. Thus, for the purpose of saving electric energy, the color screen must be frequently kept in the OFF state, unless in a necessary condition. When a corresponding car security system is triggered, the two-way anti-theft remote controller not only produces sound and vibration as warning, but also automatically turns on the color screen to show an exact condition of the triggered car security system. But the color screen will be automatically turned off after a short period of time, and only an intermittent sound will be continuously produced to remind the car owner of the triggered car security system. In the event the car owner fails to timely see the color screen, the continuously produced intermittent sound will still consume a lot of power. The car owner has to replace the battery frequently for the remote controller to maintain its normal functions.

The color screen indeed attracts a lot of consumers, but its quality varies with the manufacturing cost and the good yield thereof. A common color screen does not provide good enough display effect. The images on the color screen can be clearly seen only when the remote controller is used indoor or at a place without strong sunlight. To overcome this problem, the color screen must be a high quality and accordingly expensive product, which will no doubt increase the cost of the remote controller and reduce the product competing ability in the market.

It is therefore tried by the inventor to develop an improved display device for two-way anti-theft remote controller to overcome the above-mentioned problems in the prior art two-way anti-theft remote controller.

### SUMMARY OF THE INVENTION

A primary object of the present invention is to provide an improved display device for two-way anti-theft remote controller that includes an auxiliary indicator lamp capable of flashing in different manners or showing different colors to effectively warn a car owner about the current car state at low power consumption.

Another object of the present invention is to provide an improved display device for two-way anti-theft remote controller that includes a light sensor to enable a color screen of the display device to automatically switch between a color and a monochrome presentation mode when an ambient light source changes, so that the color screen can switch to the monochrome presentation mode or show high-contrast images when the light sensor is exposed to a strong light, enabling the car owner to always clearly see the color screen and conveniently operate the anti-theft remote controller on the color screen.

To achieve the above and other objects, the display device for two-way anti-theft remote controller according to the present invention includes a housing having a circuit board provided therein; a color screen being located at a front face of the housing; and an auxiliary indicator lamp being located on the housing to one side of the color screen. Whereby when a car security system corresponding to the two-way anti-theft remote controller is triggered, the auxiliary indicator lamp can substitute for the color screen to effectively warn a car owner about a current car state while saves electric energy that is otherwise needed by the color screen to display images. And, the display device for two-way anti-theft remote controller can further include a light sensor, which enables the color screen to automatically switch between a color and a monochrome presentation mode when an ambient light source changes. Therefore, the color screen can switch to the monochrome presentation mode or show high-contrast images when the light sensor is exposed to a strong light, enabling the car owner to always clearly see and conveniently operate the anti-theft remote controller on the color screen.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a display device for two-way anti-theft remote controller according to a preferred embodiment of the present invention;

FIG. 2 is a front view of FIG. 1 with a message shown on a color screen of the display device;

FIG. 3 is another front view of FIG. 1 with an auxiliary indicator lamp of the display device in an ON state;

FIG. 4 is a block diagram of the display device for two-way anti-theft remote controller according to another embodiment of the present invention, in which a light sensor is provided;

FIG. 5 shows the display device for two-way anti-theft remote controller according to the present invention is exposed to a sudden strong light; and

FIG. 6 shows the color screen of the display device for two-way anti-theft remote controller according to the present invention automatically switches to a monochrome presentation mode under the strong light.

### DETAILED DESCRIPTION OF THE PREFERRED EMBODIMENTS

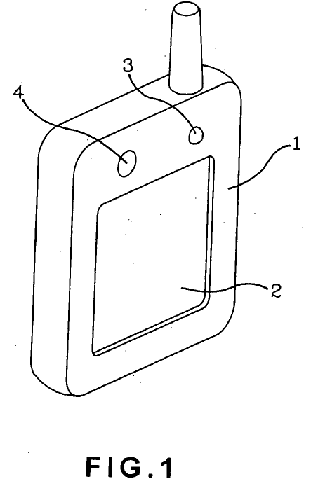

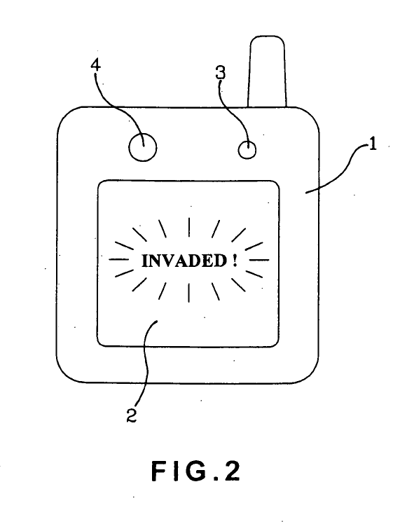

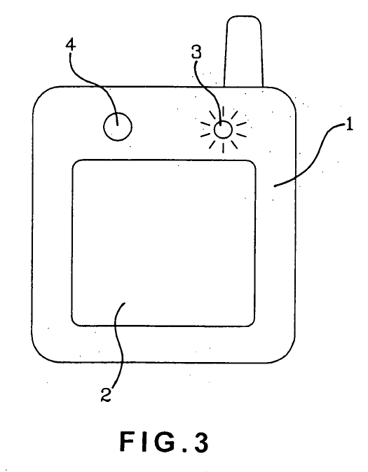

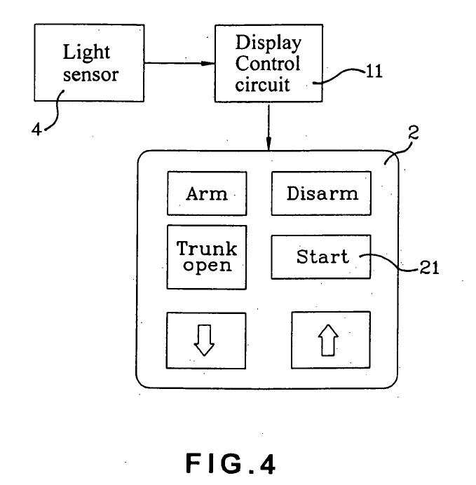

Please refer to FIGS. 1 to 4. A display device for two-way anti-theft remote controller according to a preferred embodiment of the present invention includes a housing 1, in which a circuit board (not shown) is provided; a color screen 2 being located at a front face of the housing 1; and an auxiliary indicator lamp 3 being provided on the front face of the housing 1 to one side of the color screen 2. The color screen 2 can be a touch screen. When the color screen 2 is turned on, a plurality of touch keys 21 is shown, as can be seen in FIG. 4, and a user can touch different touch keys 21 to perform different functions. The auxiliary indicator lamp 3 is a light-emitting diode (LED), which can flash or show different colors when it is in an ON state.

When a car security system corresponding to the two-way anti-theft remote controller is triggered, the auxiliary indicator lamp 3 will flash in different manners or show different colors and substitute for the color screen 2 to warn a car owner the car security system has been triggered. The car owner can turn on the color screen 2 to check for a current car state only when the auxiliary indicator lamp 3 is flashing or shows to a warning color. That is, it is not necessary for the car owner to always or frequently turn on the color screen 2 to check whether the car security system is triggered or not. Therefore, the display device for two-way anti-theft remote controller according to the present invention allows the car owner to control the actual car state at any time without consuming additional power. That is, the present invention is power-saving and practical for use.

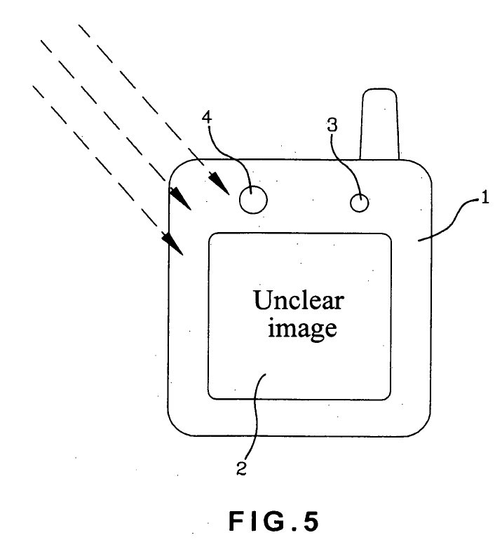

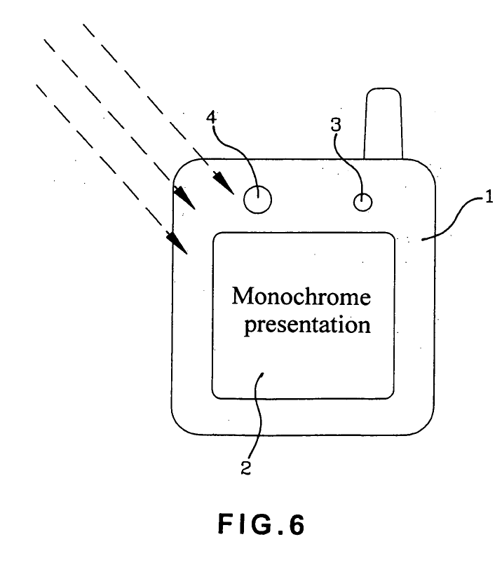

In a further embodiment of the present invention, a light sensor 4 is also provided on the housing 1 to one side of the color screen 2. When the light sensor 4 is exposed to a strong light, such as a strong sunlight, as shown in FIG. 5, a signal will be sent by the light sensor 4 to a display control circuit 11 inside the display device, so that the color screen 2 is automatically switched to a monochrome presentation mode or to show high-contrast images, as shown in FIG. 6, so that the car owner can still clearly see the touch keys 21 to conveniently and correctly touch a desired one of the touch keys 21 to perform an accurate remotely controlled operation. When the ambient light source returns to normal brightness or when the anti-theft remote controller is moved to an indoor place, the light sensor 4 of the display device can also immediately detect the change in the ambient light source and send a signal to the display control circuit 11, so that the color screen 2 can automatically switch to the color presentation mode again. With these arrangements, the display device for two-way anti-theft remote controller according to the present invention is highly humanized in terms of its image presentation function, and is novel and practical for use when compared to the prior art two-way anti-theft remote-controller.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A display device for two-way anti-theft remote controller, comprising:
a housing having a circuit board provided therein;
a color screen being located at a front face of the housing; and
an auxiliary indicator lamp being located on the housing to one side of the color screen;
whereby when a car security system corresponding to the two-way anti-theft remote controller is triggered, the auxiliary indicator lamp can function to substitute for the color screen to effectively warn a car owner about a current car state without consuming a large amount of electric power.

2. The display device for two-way anti-theft remote controller as claimed in claim 1, wherein the auxiliary indicator lamp is an LED, and can warn the car owner about the current car state by flashing in different manners or showing different colors.

3. The display device for two-way anti-theft remote controller as claimed in claim 1, wherein the color screen is a touch screen.

4. The display device for two-way anti-theft remote controller as claimed in claim 1, further comprising a light sensor provided on the house to one side of the color screen; whereby when the light sensor is exposed to a strong light, the color screen is automatically switched to a monochrome presentation mode.

5. The display device for two-way anti-theft remote controller as claimed in claim 1, further comprising a light sensor provided on the house to one side of the color screen; whereby when the light sensor is exposed to a strong light, touch keys provided on the color screen for performing different functions are automatically switched to high-contrast images thereof.
